(19) United States
(12) Patent Application Publication
(10) Pub. No.: US 2020/0092395 A1
(43) Pub. Date: Mar. 19, 2020

(54) OVERLOAD MANAGEMENT OF A TRANSACTION PROCESSING SERVER

(71) Applicant: INTERNATIONAL BUSINESS MACHINES CORPORATION, ARMONK, NY (US)

(72) Inventors: JULIAN HORN, EASTLEIGH (GB); ALAN HOLLINGSHEAD, EASTLEIGH (GB); MICHAEL D. BROOKS, SOUTHAMPTON (GB); PHILIP I. WAKELIN, EASTLEIGH (GB)

(21) Appl. No.: 16/135,186

(22) Filed: Sep. 19, 2018

(51) Int. Cl. H04L 29/08; H04L 29/06; G06F 9/50; G06F 9/46

(52) U.S. Cl. CPC H04L 67/322; H04L 67/1008; H04L 67/1012; G06F 2209/5022; G06F 9/5083; G06F 9/466; H04L 67/42

(57) ABSTRACT

Method and system are provided for overload management of a transaction processing server. The method includes detecting a high load state of a server based on a count of current transactions being processed in the server and activating prioritization of incoming client requests to the server based on prioritization of types of transaction request that reduce the load on the server. The prioritization may include: inspecting incoming client requests to determine their type and allocate a priority level; and forwarding a higher level prioritized request for processing ahead of a lower level priority request.

### BACKGROUND

The present invention relates to overload management of a transaction processing server, and more specifically, to overload management by prioritizing transaction requests.

A transaction processing server may make use of a number of network connections to receive work from its clients. These connections are generally long-lived and may support multiple concurrent requests.

The server will have a finite capacity, limited by factors such as the amount of use it can make of the central processing unit (CPU) of the machine it runs on, and the amount of memory it has access to.

A system administrator configures servers to maximize the amount of work they can support, without running the risk of stalling because of resource shortages, and takes measures to avoid it failing altogether from becoming overloaded. A limit is set on the maximum number of transactions that the server can run concurrently.

When the maximum concurrent transaction limit is reached at a server, new work is queued until existing transactions terminate. This can lead to delays in transaction request processing.

### SUMMARY

According to an aspect of the present invention there is provided a computer-implemented method for overload management of a transaction processing server, comprising: detecting a high load state of a server based on a count of current transactions being processed in the server; activating prioritization of incoming client requests to the server based on prioritization of types of transaction request that reduce the load on the server, including: inspecting incoming client requests to determine their type and allocating a priority level; and forwarding a higher level prioritized request for processing ahead of a lower level priority request.

According to another aspect of the present invention there is provided a system for overload management of a transaction processing server, comprising: a processor and a memory configured to provide computer program instructions to the processor to execute the function of components; a server capacity monitor for detecting an high load state of a server based on a count of current transactions being processed in the server; a request prioritization system for activating prioritization of incoming client requests to the server based on prioritization of types of transaction request that reduce the load on the server, including: a client request inspection component for inspecting incoming client requests to determine their type and allocating a priority level; and a request forwarding component for forwarding a higher level prioritized request for processing ahead of a lower level priority request.

According to a further aspect of the present invention there is provided a computer program product for overload management of a transaction processing server, the computer program product comprising a computer readable storage medium having program instructions embodied therewith, the program instructions executable by a processor to cause the processor to: detect a high load state of a server based on a count of current transactions being processed in the server; activate prioritization of incoming client requests in to the server based on prioritization of types of transaction request that reduce the load on the server, including: inspect incoming client requests to determine their type and allocate a priority level; and forward a higher level prioritized request for processing ahead of a lower level priority request.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings.

Preferred embodiments of the present invention will now be described, by way of example only, with reference to the following drawings in which:

FIG. 1 is a flow diagram of an example embodiment of a method in accordance with the present invention;

FIG. 2 is a schematic diagram of an example embodiment of a system in accordance with the present invention;

FIG. 3 is block diagram of an example embodiment of a system in accordance with the present invention;

FIG. 4 is a block diagram of an embodiment of a computer system or cloud server in which the present invention may be implemented;

FIG. 5 is a schematic diagram of a cloud computing environment in which the present invention may be implemented; and

FIG. 6 is a diagram of abstraction model layers of a cloud computing environment in which the present invention may be implemented.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

A method and system are described that provide overload management of a transaction processing server. A transaction processing server may process transaction requests that are received from multiple clients via a number of network connections. The connections may support multiple concurrent requests.

The server has a finite capacity and has a maximum concurrent transaction limit that may be configured by an administrator. When the limit is reached, incoming transaction requests may then be queued until existing transactions terminate and there is the capacity to process new requests. Other configurations may reject such requests. This prevents a transaction processing server from failing due to overloading.

The described method and system provide optimization of transaction request processing in a heavily loaded transaction processing server.

An overload management system is provided for managing one or more servers to detect when a server has reached a point of overload. A high load state is detected based on a count of current transactions being processed in the server. A point of overload may be before a point at which a server fails due to overloading.

When the server becomes overloaded, the method prioritizes certain types of client requests over others in order to reduce system load. The types of client requests are prioritized to ease the load by prioritizing requests that reduce the number of transactions currently being processed.

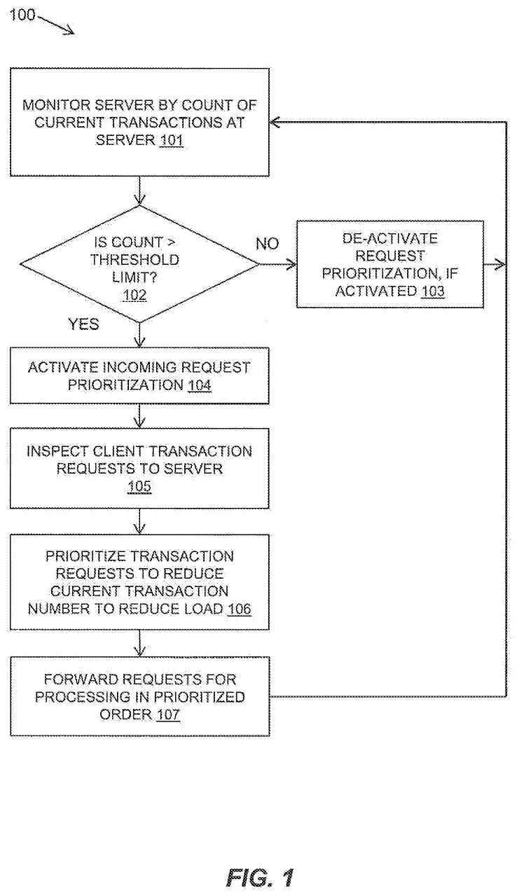

Referring to FIG. 1, a flow diagram 100 shows an example embodiment of the described method.

The method may monitor 101 a server based on a count of current transactions being processed in the server by counting current transactions. It may be detected if a high load state is reached by determining 102 if the count is above a defined threshold. The defined threshold may be below a maximum concurrent transaction level set by an administrator for a server in order to detect a high load state before the server is overloaded.

If the count is below the defined threshold, the method may deactivate 103 any previously activated prioritization and continue to monitor 101 the server to detect a high load state in the future.

If the count is above the defined threshold, the method may activate 104 incoming request prioritization.

The method may inspect 105 incoming client requests to determine their type and prioritizing 106 incoming requests to the server based on higher prioritization of types of transaction request that reduce the load on the server. This may involve allocating a priority level for client request types. Higher level prioritized requests may then be forwarded 107 for processing ahead of lower level priority requests. The prioritization may be applied to a queue of incoming client requests or a subset of requests in the queue that are closest to the top of the queue so that only a fewer number of requests are prioritized than the complete queue.

The method may loop to continue monitoring 101 the count to determine if the prioritization should remain activated or be de-activated based on a current transaction count. Therefore, if the prioritization succeeds in reducing the count of current transactions, the prioritization may be de-activated.

The prioritization may be based on rules prioritizing a top priority type of transaction request that terminates a transaction and thereby reduces the load on the server. This may include prioritizing within the top priority type transaction requests that terminate a transaction successfully with committed or backed out recoverable updates, followed by transaction requests that terminate a transaction abnormally in-flight.

The rules may give the lowest priority to a bottom priority type of transaction request that creates a new transaction for a new work request. The method may optionally decide to defer one or more bottom or lower priority types of the transaction until the system overload condition is relieved.

This leaves transaction requests that are continuations of an existing transaction with a further work request between the top and bottom priority types.

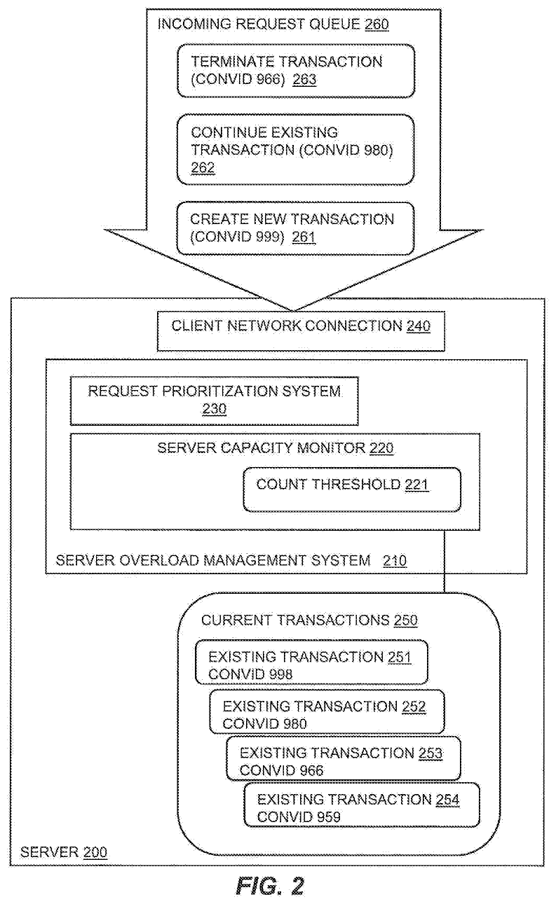

Referring to FIG. 2, a schematic diagram shows a server 200 with an incoming request queue 260 at a client network connection 240. The server 200 handles multiple current transactions 250.

Transaction processing servers often support a model of transaction execution that allows for a client-attached transaction to serve multiple requests from the client. This means that when a client request completes, the client created transaction typically waits for the next client request or waits for a request to terminate the transaction and commit/backout recoverable updates. The notification to continue with a further request or to terminate will arrive on the same network connection that created the transaction. Signals can also be received on network connections requesting that an in-flight transaction should be terminated abnormally.

There are typically four types of transaction processing requests that may arrive over a client network connection 240:

Type 1: A request to create a new transaction for a new work request.

Type 2: A request to continue an existing transaction with a further work request.

Type 3: A request to terminate a transaction and commit/backout recoverable updates.

Type 4: A request to terminate an in-flight transaction abnormally.

Type 1 increases the load on the transaction processor by adding a new transaction.

Type 2 does not increase or decrease the load but it does allow an existing transaction to move a step closer to completion.

Type 3 and 4 decrease the load on the transaction processor as they trigger transaction termination.

When the server is close to becoming overloaded, the described server overload management system 210 prioritizes certain types of client requests over others in order to reduce system overload.

The prioritization order for the server overload management system 210 may be:

(A) Type 3: Request to terminate a transaction and commit/backout recoverable updates.

(B) Type 4: Request to terminate an in-flight transaction abnormally.

(C) Type 2: Request to continue an existing transaction with a further work request.

(D) Type 1: Request to create a new transaction for a new work request.

FIG. 2 illustrates a server 200 which includes a server overload management system 210 that includes a server capacity monitor 220 which keeps track of the existing transaction count and uses this in conjunction with a transaction limit in the form of a count threshold 221 to decide when to activate or de-activate a request prioritization system 230 when the server 200 is close to overloaded or no longer close to overloaded.

The request prioritization system 230 may inspect incoming requests from clients on the client network connection 240 before receiving them.

When the request prioritization system 230 is activated, instead of processing client requests in the order they arrive, it prioritizes those requests, which will cause a transaction to terminate and therefore reduce the current transaction workload.

FIG. 2 shows existing transactions 250 in the server 200 including “conversation ID 998” 251, “conversation ID 980” 252, “conversation ID 966” 253, and “conversation ID 959” 254. The incoming request queue 260 includes a top request 261 in the queue 260 to create a new transaction with conversation ID 999, a second request 262 in the queue 260 to continue existing transaction conversation ID 980 and a third request 263 in the queue 260 to terminate transaction conversation ID 966.

In the diagram, the first request 261 will add to the overload by creating a new transaction so this is the least favored type of request.

The second request 262 continues an existing transaction, so this will not increase the server load but it will not decrease it either.

The third request 263 will terminate a transaction so it will relieve some of the load.

So the request prioritization system 230 would process the third request 263, then the second request 262, and then the first request 261 rather than the default order of arrival.

The prioritization system 230 may optionally decide to defer the first request 261 until the system overload condition is relieved.

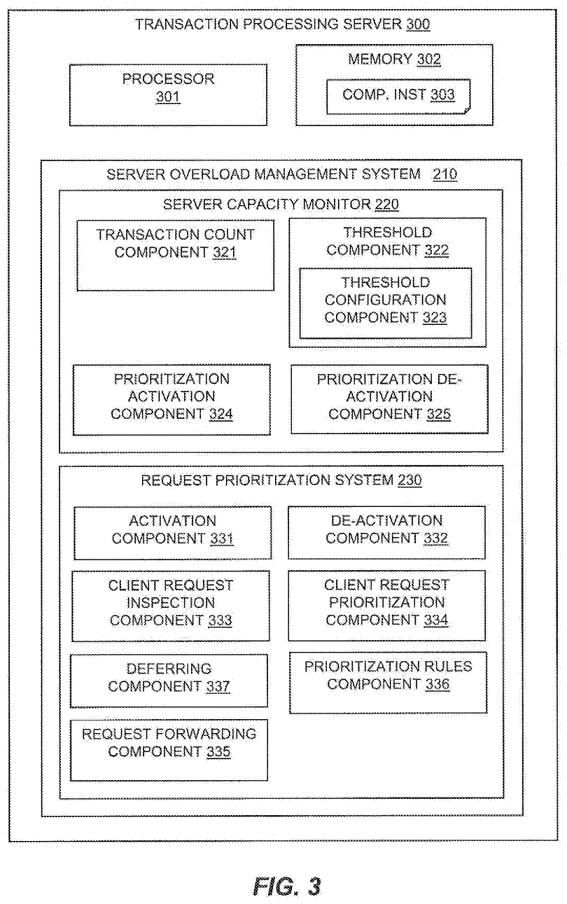

Referring to FIG. 3, a block diagram an example embodiment of a transaction processing server 300 that may form or be part of a server 200.

The transaction processing server 300 may include at least one processor 301, a hardware module, or a circuit for executing the functions of the described components which may be software units executing on the at least one processor. Multiple processors running parallel processing threads may be provided enabling parallel processing of some or all of the functions of the components. Memory 302 may be configured to provide computer instructions 303 to the at least one processor 301 to carry out the functionality of the components.

The transaction processing server 300 may include a server overload management system 210 including a server capacity monitor 220 for detecting a high load state of a server based on a count of current transactions being processed in the server and a request prioritization system 230 for activating prioritization of incoming requests in a queue to the server based on prioritization of types of transaction request that reduce the load on the server.

The server capacity monitor 220 may include a transaction count component 321 for monitoring a count of current transactions being processed in the server and a threshold component 322 for determining if the number of current transactions is above a defined threshold count. The threshold component 322 may include a threshold configuration component 323 for configuring a defined threshold below a maximum concurrent transaction limit of the server.

The server capacity monitor 220 may include a prioritization activation component 324 for activating a prioritization of incoming transaction requests when a high load state is detected and a prioritization de-activation component 325 for de-activating a prioritization of incoming transaction requests when the high load state is no longer detected. The prioritization activation component 324 and prioritization de-activation component 325 may be provided by a single component that changes between the two states.

The request prioritization system 230 may include an activation component 331 for activating the functionality when a high load state is detected by the server capacity monitor 220 and a de-activation component 332 de-activating a prioritization of incoming transaction requests when the high load state is no longer detected. The activation component 331 and the de-activation component 332 may be provided by a single component that changes between two states.

The request prioritization system 230 may include a client request inspection component 333 for inspecting incoming client requests to determine their type, a client request prioritization component 334 for prioritizing the requests according to a prioritization rules component 336, and a request forwarding component 335 for forwarding a prioritized queued request for processing.

The prioritization rules component 336 may prioritize a top priority type of transaction request that terminates a transaction and thereby reduces the load on the server, and prioritizing within the top priority type transaction requests that terminate a transaction successfully with committed or backed out recoverable updates, followed by transaction requests that terminate a transaction abnormally in-flight.

The prioritization rules component 336 may prioritize a bottom priority type of transaction request that creates a new transaction for a new work request. A deferring component 337 may defer a bottom priority type of transaction until an overload condition is relieved.

In one embodiment, the prioritization rules component 336 determines the following types of transaction and prioritizes them as follows:

(A) the first type of transaction request that requests termination of a transaction and commits or backout recoverable updates;

(B) the second type of transaction request that requests termination of an in-flight transaction abnormally;

(C) a third type of transaction request that requests continuation of an existing transaction with a further work request; and

(D) a fourth type of transaction request that requests the creation of a new transaction for a new work request.

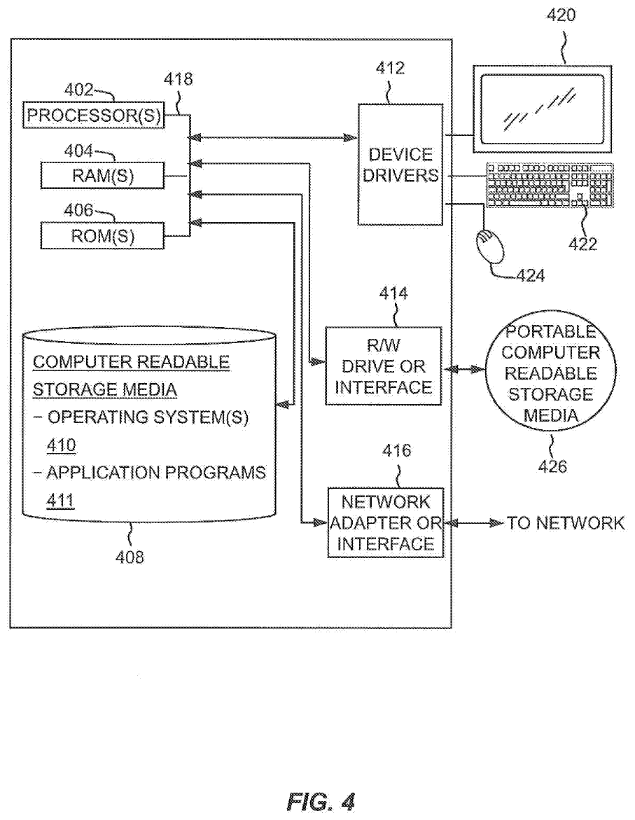

FIG. 4 depicts a block diagram of components of the computing device of the transaction processing server 300 of FIG. 3, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Computing device can include one or more processors 402, one or more computer-readable RAMs 404, one or more computer-readable ROMs 406, one or more computer readable storage media 408, device drivers 412, read/write drive or interface 414, and network adapter or interface 416, all interconnected over a communications fabric 418. Communications fabric 418 can be implemented with any architecture designed for passing data and/or control information between processors (such as microprocessors, communications and network processors, etc.), system memory, peripheral devices, and any other hardware components within the system.

One or more operating systems 410, and application programs 411, such as the server overload management system 210 are stored on one or more of the computer readable storage media 408 for execution by one or more of the processors 402 via one or more of the respective RAMs 404 (which typically include cache memory). In the illustrated embodiment, each of the computer readable storage media 408 can be a magnetic disk storage device of an internal hard drive, CD-ROM, DVD, memory stick, magnetic tape, magnetic disk, optical disk, a semiconductor storage device such as RAM, ROM, EPROM, flash memory, or any other computer readable storage media that can store a computer program and digital information, in accordance with embodiments of the invention.

Computing device can also include a R/W drive or interface 414 to read from and write to one or more portable computer readable storage media 426. Application programs 411 on computing device can be stored on one or more of the portable computer readable storage media 426, read via the respective R/W drive or interface 414 and loaded into the respective computer readable storage media 408.

Computing device can also include a network adapter or interface 416, such as a TCP/IP adapter card or wireless communication adapter. Application programs 411 on computing device can be downloaded to the computing device from an external computer or external storage device via a network (for example, the Internet, a local area network or other wide area networks or wireless networks) and network adapter or interface 416. From the network adapter or interface 416, the programs may be loaded into the computer readable storage media 408. The network may comprise copper wires, optical fibers, wireless transmission, routers, firewalls, switches, gateway computers and edge servers.

Computing device can also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414, and network adapter or interface 416 can comprise hardware and software stored in computer readable storage media 408 and/or ROM 406.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the users computer and partly on a remote computer or entirely on the remote computer or server. In the latter scenario, the remote computer may be connected to the users computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Cloud Computing

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

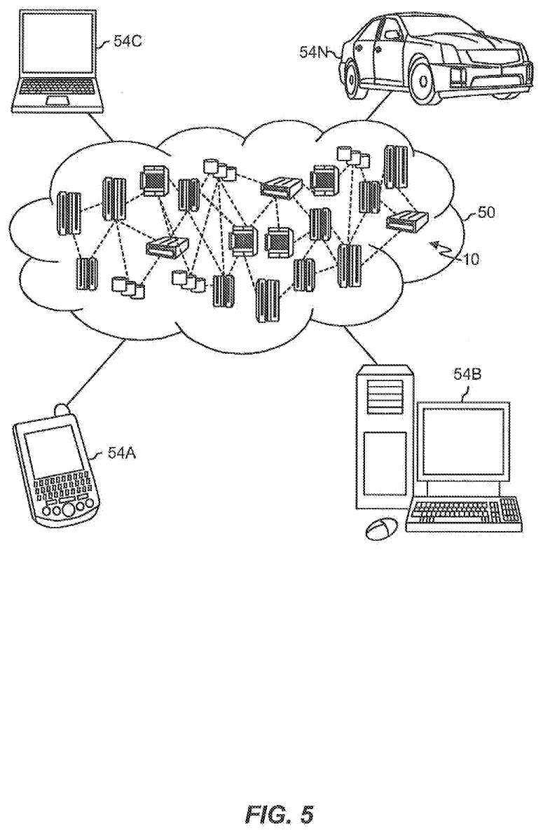

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

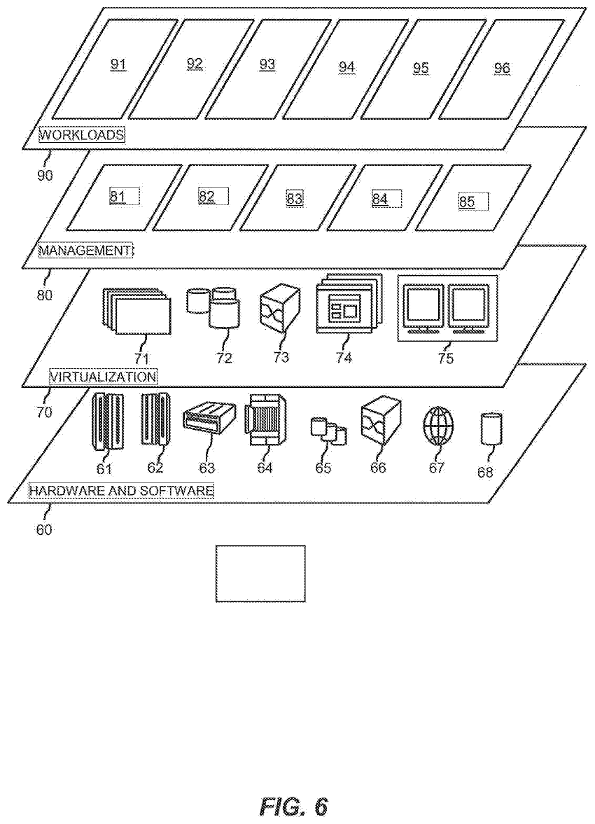

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and transaction server overload management 96.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A computer-implemented method for overload management of a transaction processing server, comprising:
detecting a high load state of a server based on a count of current transactions being processed in the server;
activating prioritization of incoming client requests to the server based on prioritization of types of transaction request that reduce the load on the server, including:
inspecting incoming client requests to determine their type and allocating a priority level; and
forwarding a higher level prioritized request for processing ahead of a lower level priority request.

2. The method as claimed in claim 1, including prioritizing a top priority type of transaction request that terminates a transaction and thereby reduces the load on the server.

3. The method as claimed in claim 2, including prioritizing within the top priority type transaction requests that terminate a transaction successfully with committed or backed out recoverable updates, followed by transaction requests that terminate a transaction abnormally in-flight.

4. The method as claimed in claim 2, including prioritizing a bottom priority type of transaction request that creates a new transaction for a new work request.

5. The method as claimed in claim 4, including deferring a bottom priority type of transaction until an overload condition is relieved.

6. The method as claimed in claim 1, including determining the following types of transaction and prioritizing them with prioritization levels as follows:
a first type of transaction request that requests termination of a transaction and commit or backout recoverable updates;
a second type of transaction request that requests termination of an in-flight transaction abnormally;
a third type of transaction request that requests continuation of an existing transaction with a further work request; and
a fourth type of transaction request that requests creation of a new transaction for a new work request.

7. The method as claimed in claim 1, wherein detecting a high load state includes:
counting current transactions at the server; and
determining whether a number of current transactions is above a defined threshold count.

8. The method as claimed in claim 7, wherein the defined threshold is below a maximum concurrent transaction limit of the server.

9. The method as claimed in claim 1, including detecting that a high load state has passed and de-activating the prioritization of incoming requests.

10. The method as claimed in claim 1, including activating prioritization of a subset of requests in a queue of incoming requests that are closest to a top of the queue.

11. A system for overload management of a transaction processing server, comprising:
a processor and a memory configured to provide computer program instructions to the processor to execute a function of components;
a server capacity monitor for detecting a high load state of a server based on a count of current transactions being processed in the server;
a request prioritization system for activating prioritization of incoming client requests to the server based on prioritization of types of transaction request that reduce the load on the server, including:
a client request inspection component for inspecting incoming client requests to determine their type and allocating a priority level; and
a request forwarding component for forwarding a higher level prioritized request for processing ahead of a lower level priority request.

12. The system as claimed in claim 11, including a prioritization rules component for prioritizing a top priority type of transaction request that terminates a transaction and thereby reduces the load on the server.

13. The system as claimed in claim 12, wherein the prioritization rules component includes prioritizing within the top priority type transaction requests that terminate a transaction successfully with committed or backed out recoverable updates, followed by transaction requests that terminate a transaction abnormally in-flight.

14. The system as claimed in claim 12, wherein the prioritization rules component includes prioritizing a bottom priority type of transaction request that creates a new transaction for a new work request.

15. The system as claimed in claim 12, wherein the prioritization rules component determines the following types of transaction and prioritizes them with prioritization levels as follows:
a first type of transaction request that requests termination of a transaction and commit or backout recoverable updates;
a second type of transaction request that requests termination of an in-flight transaction abnormally;
a third type of transaction request that requests continuation of an existing transaction with a further work request; and
a fourth type of transaction request that requests creation of a new transaction for a new work request.

16. The system as claimed in claim 11, wherein the server capacity monitor for detecting a high load state includes:
a transaction count component for counting current transactions at the server; and
a threshold component for determining whether a number of current transactions is above a defined threshold count.

17. The system as claimed in claim 16, wherein the server capacity monitor for detecting a high load state includes:
a prioritization activation component for activating a prioritization of incoming transaction requests when a high load state is detected; and
a prioritization de-activation component for de-activating a prioritization of incoming transaction requests when the high load state is no longer detected.

18. The system as claimed in claim 17, wherein the threshold component includes a threshold configuration component for configuring a defined threshold below a maximum concurrent transaction limit of the server.

19. The system as claimed in claim 11, including a deferring component for deferring one or more bottom priority types of transaction until an overload condition is relieved.

20. A computer program product for overload management of a transaction processing server, the computer program product comprising a computer readable storage medium having program instructions embodied therewith, the program instructions executable by a processor to cause the processor to:
detect a high load state of a server based on a count of current transactions being processed in the server;
activate prioritization of incoming client requests in to the server based on prioritization of types of transaction request that reduce the load on the server, including:
inspect incoming client requests to determine their type and allocate a priority level; and
forward a higher level prioritized request for processing ahead of a lower level priority request.
